(19) United States
(12) Patent Application Publication
(10) Pub. No.: US 2025/0005001 A1
(43) Pub. Date: Jan. 2, 2025

(54) ADAPTIVE OUTLIER DETECTION AND CORRECTION

(71) Applicant: International Business Machines Corporation, Armonk, NY (US)

(72) Inventors: Tobias Kevin Fränzel, Tuebingen (DE); Werner Schuetz, Nufringen (DE); Toni Bollinger, Weil der Stadt (DE); James Liam Finnie, Boeblingen (DE); Oliver Schiller, Dettingen unter Teck (DE); Thomas Friedhelm Böhme, Böblingen (DE)

(73) Assignee: International Business Machines Corporation, Armonk, NY (US)

(21) Appl. No.: 18/216,101

(22) Filed: Jun. 29, 2023

(51) Int. Cl. G06F 16/215; G06N 20/00

(52) U.S. Cl. CPC G06F 16/215; G06N 20/00

(57) ABSTRACT

An embodiment detects, by an outlier detector, a first potential outlier in a data structure. The embodiment determines, by the outlier detector, whether the first potential outlier is a first outlier based on a first threshold. The embodiment applies, by an outlier corrector, responsive to determining the first potential outlier is a first outlier, a data quality rule to the first outlier. The embodiment detects, by the outlier detector, a second potential outlier in the data structure. The embodiment decreases, by the outlier detector, the first threshold to a second threshold. The embodiment determines, by the outlier detector, whether the second potential outlier is a second outlier based on the second threshold. The embodiment applies, by the outlier corrector, responsive to determining the second potential outlier is a second outlier, the data quality rule to the second outlier.

### BACKGROUND

The present invention relates generally to data analysis. More particularly, the present invention relates to a method, system, and computer program for adaptive outlier detection and correction.

In the realm of data analysis, outlier detection plays a critical role. Outliers are data points that significantly differ from the other observations in the data set. These discrepancies can occur due to various reasons such as measurement errors, data entry errors, or genuine variability in the data. Outlier detection techniques are vital in statistical data analysis, as the presence of outliers can potentially skew the results, causing inaccurate predictions or assessments. Data entry error is one common source of outliers. This could be a result of human error during the data entry process, or issues with the software used to input or transfer the data. For instance, a user might accidentally add an extra digit to a numerical value, or a software glitch might cause some entries to be incorrectly recorded or transformed. Regardless of their source, outliers can have significant impacts on data analysis as they can lead to misleading results and inaccurate predictions.

### SUMMARY

The illustrative embodiments provide for adaptive outlier detection and correction. An embodiment includes detecting, by an outlier detector, a first potential outlier in a data structure. The embodiment also includes determining, by the outlier detector, whether the first potential outlier is a first outlier based on a first threshold. The embodiment also includes applying, by an outlier corrector, responsive to determining the first potential outlier is a first outlier, a data quality rule to the first outlier. The embodiment also includes detecting, by the outlier detector, a second potential outlier in the data structure. The embodiment also includes decreasing, by the outlier detector, the first threshold to a second threshold. The embodiment also includes determining, by the outlier detector, whether the second potential outlier is a second outlier based on the second threshold. The embodiment also includes applying, by the outlier corrector, responsive to determining the second potential outlier is a second outlier, the data quality rule to the second outlier. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example system for adaptive outlier detection and correction in accordance with an illustrative embodiment.

FIG. 4 depicts a block diagram of an example process for adaptive outlier detection and correction in accordance with an illustrative embodiment.

FIG. 5 depicts a block diagram of an example process for adaptive outlier detection in accordance with an illustrative embodiment.

FIG. 6 depicts a block diagram of an example process for data quality rule monitoring in accordance with an illustrative embodiment.

FIG. 7 depicts a block diagram of an example process for applying a data quality rule to data in accordance with an illustrative embodiment.

FIG. 8 depicts a block diagram of an example process for monitoring for outliers in accordance with an illustrative embodiment.

FIG. 9 depicts a block diagram of an example process for detection and correction of a level shift outlier in accordance with an illustrative embodiment.

FIG. 10 depicts a block diagram of an example process for outlier detection and correction in accordance with an illustrative embodiment.

### DETAILED DESCRIPTION

Outlier detection is a fundamental component of data analysis that helps ensure the reliability and accuracy of the results. Outliers, which differ from other data points in a dataset, can introduce a degree of bias or error into the analysis. These outliers can be the result of a range of factors. Outlier detection techniques help ensure the integrity of data analysis. These techniques can help identify and manage outliers, enabling more accurate and reliable interpretations of data. Existing methods for detecting outliers, however, suffer from a range of issues.

One issue is the lack of a comprehensive process that goes beyond simply identifying outliers, to understanding the causes behind them and proposing solutions. Current outlier detection techniques often stop at detection, leaving the cause undiagnosed and the problem unresolved. This lack of thorough investigation can lead to a recurrence of similar outlier issues in the future, which compromises the reliability of the data over time. Another challenge in outlier detection is the static nature of sensitivity thresholds. Many existing methods use fixed parameters for detecting outliers, which may not be suitable for all datasets. This lack of adaptability can result in an excessive number of false positives or negatives, leading to poor precision or recall. In addition, many current outlier detection systems lack an automatic learning and correction mechanism. Once outliers are detected and corrected, it is critical to use that knowledge to prevent similar errors in the future. Lastly, there is often a need for expert intervention in the process of outlier detection and correction, which can be time-consuming and costly.

The present disclosure addresses the deficiencies described above by providing a process (as well as a system, method, machine-readable medium, etc.) that efficiently detects and rectifies erroneous outliers in data.

The illustrative embodiments provide for adaptive outlier detection and correction in data structures. “Adaptive,” as used herein, may refer to the ability of a system or method to automatically adjust its behavior or parameters based on the data or conditions it encounters.

Thus, the system or method may be dynamic and may optimize its performance based on changing circumstances or requirements. An “outlier,” as used herein, may refer to a data point that differs from other observations in a dataset. Outliers could be anomalously high or low values that do not align with the general trend or distribution of the data. They can occur for a variety of reasons, including measurement errors, data entry errors, or due to the natural variability present in the data, among other reasons. In some embodiments, however, outliers are not necessarily incorrect or undesirable data points; in some cases, they can represent important real-world phenomena or valuable insights. A “data structure,” as used herein, may refer to an organized container of data the contents of which may be accessed and manipulated. This can include structures such as columns, tables, arrays, matrices, linked lists, trees, heaps, and graphs. It may also refer to data organized in a database or other data storage systems, including tables, records, files, or objects in an object-oriented database.

In some embodiments, for example, a data structure may include a table comprising a plurality of columns, with a column having one or more potential outliers associated with that column. In such cases, each column in the table may represent a specific data field, such as a variable or attribute, and each row represents a single record or instance. The potential outliers may be data points within a specific column that deviate significantly from other values within the same column, possibly indicating an anomaly or error. The outlier detection and correction system identifies these potential outliers and applies suitable corrective measures to ensure data quality and integrity.

Outlier detection may involve identifying outliers in a dataset, such as through the use of one or more statistical methods, clustering methods, machine learning methods, neural network-based methods, or any other method. The choice of technique may depend on the nature of the data and the specific requirements of the analysis. For instance, a machine learning model trained using Riemannian geometric principles can be employed, particularly when dealing with time series data. In this method, each time series may be treated as a point on a Riemannian manifold, effectively mapping the time series data into a geometric space. The model may learn the underlying structure of this manifold using historical data and can then detect outliers as those points that are a significant geodesic distance away from the majority, based on the intrinsic geometry of the data manifold. Adaptations of classic machine learning algorithms, such as the k-nearest neighbors (k-NN) or the use of Riemannian kernels, can be employed in this geometrically transformed space to enhance outlier detection.

As another example, the Z-score method may be used, which identifies outliers based on the principle of standard deviation. In this method, each data point's Z-score is calculated, which represents how many standard deviations the point is from the mean. Any data points with a Z-score greater than a predefined threshold (e.g., 3 or −3) may be flagged as outliers. Another may be the Interquartile Range (IQR) method. In this method, the dataset is divided into quartiles and the IQR, which is the range between the first quartile (25th percentile) and the third quartile (75th percentile), is calculated. Any data point that falls below the first quartile minus 1.5 times the IQR, or above the third quartile plus 1.5 times the IQR, may be considered an outlier. Another approach may be to use graphical methods like box plots and scatter plots, which provide visual ways of spotting outliers. For multi-dimensional data, machine learning techniques like clustering may be used. This technique involves grouping data points based on similarity, and anomalies may be detected as points that fall outside these groups, or classification, where a model is trained to classify points as normal or outliers, can be used. Additionally, density-based methods like Local Outlier Factor (LOF) may be used, which works by assessing the density of data points' neighborhoods, identifying outliers as points in low-density regions. Other methods to detect outliers may be used, however, as would be appreciated by those skilled in the art upon reviewing the present disclosure.

Correction of outliers may involve adjusting or modifying outlier data points to improve the accuracy and reliability of the dataset, as discussed herein. This could involve fixing errors or anomalies, or it could involve making adjustments to account for biases or inconsistencies in the data. The process of outlier correction can be as varied as the detection techniques and may depend on the nature of the outliers and the dataset. One method to correct an outlier is to remove it, especially if it is due to a measurement or data entry error. However, this approach may not always be suitable as it may result in loss of valuable information. If the outliers are due to measurement or data entry errors, and the correct value can be determined or estimated, substitution may be used as a method for correction. The outlier value can be replaced with a more probable value, such as the mean, median, or mode of the dataset, or even a random value drawn from the data distribution. For example, if the Z-score or IQR method flags a data point as an outlier, it could be replaced with the mean or median of the other data points. When using machine learning or neural network-based methods, the correction could involve retraining the model after removing or adjusting the outliers, thereby improving the model's future predictions. For methods like LOF, a potential correction strategy could involve adjusting the point's location in the feature space, moving it closer to its nearest neighbors. In some embodiments, statistical or machine learning techniques might be used to predict a more likely value for the outlier, based on the patterns or relationships in the rest of the data.

Illustrative embodiments include generating a hypothesis about a cause of an outlier data point. A “hypothesis,” as used herein, may refer to a tentative explanation or prediction that can be tested through further investigation. It may represent the system's educated guess of an outlier based on current knowledge and data. A “cause,” as used herein, may refer to the reason or factor that has led to a particular outcome or phenomenon—in this case, the presence of an outlier data point. The cause of an outlier could be a wide range of factors, such as measurement errors, data entry errors, changes in the underlying phenomenon being measured, or natural variability in the data. By generating a hypothesis about the cause of an outlier, the system can take a systematic and informed approach to investigating the outlier, potentially leading to more effective detection and correction strategies.

Illustrative embodiments involve validating the hypothesis with one or more other data points. Validation may involve comparing the predictions or implications of the hypothesis with actual observed data. If the hypothesis accurately predicts or explains the other data points, then the hypothesis is said to be validated. However, if the other data points do not align with what the hypothesis predicts or suggests, then the hypothesis may need to be revised or rejected.

For instance, consider an example where a dataset contains an outlier—an unusually high value-which could be a measurement error, a data entry error, or a genuine extreme observation. A hypothesis might be generated that the outlier is a result of a data entry error, where a value has been accidentally entered as “1000” instead of “100.” In the validation process, the system may look for other data points that may support this hypothesis. For instance, if all other values in the dataset are in the range of 50-150, and this is the only value that is significantly larger, this could support the hypothesis of a data entry error. Further validation could involve examining the time and date of the data entry. If the outlier was inputted at an unusual time (for example, late at night), this could suggest a higher likelihood of human error.

Another example could be validating a hypothesis about a systemic measurement error. Suppose the outlier data is part of a time-series data set, and the system hypothesizes that the outlier is due to a change in measurement units (from inches to centimeters, for example) at a certain point in time. The system could validate this hypothesis by examining the data points before and after the suspected change point. If there's a consistent increase or decrease in values after this point, it would support the hypothesis.

Illustrative embodiments include determining a correction of the outlier data point based on the validated hypothesis. This process may involve deciding how to adjust an anomalous data point, using insights gained from a hypothesis that has been tested and found to be plausible. For instance, if the hypothesis suggests that the outlier resulted from a data entry error, then a correction might involve substituting the outlier with a more plausible value, which could be derived from the overall distribution of data, or based on some known relationships or rules specific to the data context. If the hypothesis points to a systemic measurement error, the correction might involve a conversion or adjustment of all data points from a certain time point. In a machine learning context, where the hypothesis might suggest the presence of an unaccounted influential feature, the correction could involve adjusting the model to include the new feature, thus recalibrating the outlier. This process may provide a comprehensive strategy for handling outliers in data analysis.

Illustrative embodiments include adaptively adjusting a threshold of the outlier detection. A “threshold,” as used herein, may refer to a defined limit or boundary that separates a normal data point from an outlier. The setting of this threshold could be based on statistical measures like standard deviations or interquartile ranges, or on domain-specific criteria. Adaptive adjustment may involve changing the threshold in response to various factors. For example, if an outlier is identified, the threshold may be decreased to identify other outliers in the vicinity of the identified outlier. Conversely, if the variance in the data increases, the threshold for outlier detection may be increased to accommodate the increased spread of data. This process may ensure that the outlier detection is responsive and attuned to the characteristics of the data, enhancing its robustness and accuracy.

In some embodiments, a threshold may be based at least on one of a mean, a median, and a standard deviation. These statistical measures may provide insights into the central tendency and dispersion of the data, which can be utilized to distinguish normal data points from outliers. The mean may represent the average of the dataset, the median may be the middle point that separates the higher half from the lower half of the data sample, and the standard deviation may measure the amount of variation or dispersion in the data. A combination of these measures could be employed to set a dynamic threshold. For instance, a data point that is a certain number of standard deviations away from the mean or median could be classified as an outlier. This may ensure that the threshold adapts to the inherent structure and variation of the data, leading to more accurate and meaningful outlier detection.

In some embodiments, a greater number of identified outliers may lead to a lower threshold. This may involve adjusting the threshold responsive to the prevalence of outliers in the data. For example, if an analysis detects a high number of outliers, it could suggest that the data is more likely an outlier, and therefore, the threshold could be lowered. Conversely, if fewer outliers are identified, the system may increase the threshold, thereby making it more challenging for a data point to be labeled as an outlier. This dynamic adjustment of the threshold can help accommodate variations in different data sources, striking a balance between flagging true outliers and avoiding false positives. Additionally, the threshold can be manually adjusted to meet specific criteria or to fine-tune the outlier detection process.

In some embodiments, a tradeoff between precision and recall may be automatically adjusted based on a data source. In the context of outlier detection, precision may refer to the proportion of true outliers (data points that are actually outliers) among all data points flagged as outliers, while recall may refer to the proportion of true outliers that were correctly identified by the system. There is often a tradeoff between these two metrics: setting a high threshold may yield high precision (less false positives) but low recall (missed outliers), while a low threshold may yield high recall (few missed outliers) but low precision (more false positives). An embodiment may allow for an automatic adjustment of this tradeoff, influenced by the characteristics of the data source. For example, in a highly sensitive application where missing an outlier could have serious consequences, the system may be tuned to prioritize recall, even at the cost of precision. Conversely, in situations where false positives could be disruptive, the system might prioritize precision. This adaptability allows for a more nuanced and context-sensitive approach to outlier detection and correction.

Illustrative embodiments include determining whether a potential outlier is an additive outlier indicating a deviation at a particular data point. An “additive outlier,” as used herein, may refer to an outlier that deviates from an anticipated value at a particular data point. It is called “additive” because this outlier may be considered as an addition or subtraction of a certain amount from the expected value at that data point. For example, if the system monitors dates in a data column and one date is much later or earlier in time than the usual range, this could be an additive outlier indicating an entry error.

Determining whether a potential outlier is an additive outlier could be based on various statistical measures or machine learning methods. For instance, a Z-score (a measure of how many standard deviations an observation is from the mean) can be calculated for each data point, and those with absolute Z-scores above a certain threshold may be flagged as potential additive outliers. Additionally or alternatively, machine learning algorithms could be employed, which may be trained for instance using historical timeseries data, or any other data representative of the dataset's normal patterns.

Illustrative embodiments include converting, responsive to a determination that the potential outlier is an additive outlier, the potential outlier to a standardized value. A “standardized value,” as used herein, may refer to a transformed or adjusted value that has been made compatible or consistent with a certain standard for ease of comparison and computation. This process may be aimed at minimizing potential discrepancies or ambiguities that may arise due to differences in data formats or scales. For example, standardizing a date may involve converting the date into Julian format. This transforms the date data into a consistent format of the number of days elapsed since a fixed point in time (November 24, 4714 BC in the Julian system), thereby allowing more straightforward mathematical operations and comparisons to be performed on the date data.

Illustrative embodiments include determining whether the potential outlier is an outlier by applying a threshold to the standardized value. This threshold could be a fixed value, or it could be dynamically adjusted based on the dataset, such as based on a distribution of standardized values in the dataset. For example, the threshold could be set at a certain number of standard deviations away from the mean, such as two standard deviations in a normal distribution.

Illustrative embodiments include determining whether a potential outlier is a level shift outlier indicating a deviation at a plurality of data points. A “level shift outlier,” as used herein, may refer to an outlier that shares a change in base level similar to other data points. Instead of a single point deviation like an additive outlier, a level shift outlier may indicate a consistent change in the data's behavior. For example, if the system monitors revenue entries in a data column and a number of entries after a particular time have increased by a fixed scale value, these could be level shift outliers indicating a currency conversion error (e.g., pounds to euros, or vice versa).

Determining whether a potential outlier is a level shift outlier could include employing time series analysis methods or change point analysis methods that identify points in a dataset where the statistical properties of the data change. Additionally or alternatively, a machine learning-based anomaly detection algorithm, such as isolation forest or autoencoder neural networks, could be employed. These methods can be trained on historical data to learn the normal patterns, and then be used to detect deviations from these patterns in new data. They can also be tested on a validation dataset to assess their robustness, accuracy, and ability to generalize to unseen data. The selection of the algorithm may depend on factors such as the nature of the data, the type of level shift outliers that are likely to occur, and the computational resources available.

Illustrative embodiments include applying, responsive to a determination that the potential outlier is a level shift outlier, a heuristic to the potential outlier to compute a heuristic value. A “heuristic,” as used herein, may refer to a criteria for determining the validity of a potential outlier. It may take into consideration several factors or criteria. For instance, if the data structure is a series of columns, the heuristic may take into account the data classification, the data type, the table name, the column name, the cell values, and/or whether the column has a subset of the relevant data quality rules, among other factors. Each of these criteria may be assigned a weight, reflecting its relative importance in determining the validity of a potential outlier. For instance, the data type might be given more weight than the column name if it is generally found to be a more reliable indicator of measurement status. A “heuristic value,” as used herein, may be the sum of the weights of the heuristic criteria, such as all the criteria that a data structure meets.

Illustrative embodiments include determining whether the potential outlier is an outlier by applying a threshold to the heuristic value. This threshold could be dynamically adjusted based on factors such as the distribution of heuristic values across the data structure, the cost or consequences of false positives or false negatives in outlier detection, and the potential impact of outliers on downstream applications or decision-making processes. The threshold could be set in a variety of ways, such as by specifying a percentile of the heuristic values (e.g., any data point with a heuristic value in the top 1% is considered an outlier), a fixed value (e.g., any data point with a heuristic value above 0.5 is considered an outlier), or a value derived from a statistical analysis of the data (e.g., any data point with a heuristic value more than three standard deviations away from the mean is considered an outlier). These settings could be fine-tuned based on feedback from the users or the performance of the outlier detection process in practice.

Illustrative embodiments include proposing a data quality rule based on the determined correction. A “data quality rule,” as used herein, may refer to a predefined guideline, constraint, or requirement that is used to ensure and improve the quality of data in a dataset or a database. This functionality may represent a proactive approach to handling outliers, where the understanding gained from correcting an outlier is used to guide future data collection, entry, or analysis processes. A data quality rule might take the form of a guideline or constraint that aims to ensure the reliability and accuracy of the data. For instance, if an outlier was due to a data entry error where dates were entered using the wrong date format (e.g., MM/DD/YY instead of DD/MM/YY), the correction might involve applying the correct date format to the outliers. Based on this, the proposed data quality rule could specify the acceptable date format for future data entry. Similarly, if an outlier resulted from a unit conversion error (e.g., inches instead of centimeters), the correction might involve adjusting the affected values, and the associated data quality rule might mandate a consistent unit of measurement across the dataset. By proposing data quality rules based on identified and corrected outliers, these embodiments help prevent similar errors in the future.

In some embodiments, a data quality rule may be defined by a user. A data quality rule may be received through any suitable means, such as a through a graphical user interface or data file. This feature allows the user to establish rules based on their specific needs, domain knowledge, and understanding of the context of the data. For instance, a medical researcher could implement a rule stating that patient age should not exceed 120 years, reflecting realistic human lifespan limits. Similarly, a user working with financial data might set a rule that all transactions must have a non-negative value, based on the understanding that transactions cannot have negative amounts. Such user-defined rules offer a level of customization and specificity that can enhance the accuracy and relevance of the data quality control process. In effect, by allowing for user-defined data quality rules, the system may cater to a wide range of applications and adapt to various scenarios, improving the quality and reliability of the data and thereby enhancing the validity of any subsequent data analyses or operations.

Illustrative embodiments include applying a data quality rule to other data points. This may involve taking a rule that was formulated based on a particular outlier or a set of outliers, and then applying this rule across other data points in the dataset. For instance, if a data quality rule was created to correct a date format issue for a specific outlier, this rule can then be applied across other data tables or columns to correct any similar date format issues. This approach may help ensure consistency and uniformity across the dataset, enhancing the overall quality of the data. It also promotes efficiency, as the lessons learned from correcting specific outliers are leveraged to improve the broader dataset, reducing the need for repetitive, manual corrections.

Illustrative embodiments include determining, based on applying a data quality rule to other data points, whether the data quality rule increases a number of outliers. In such embodiments, the system could assess the impact of a newly introduced rule by monitoring changes in the number of detected outliers. For instance, if a data quality rule was designed to correct formatting inconsistencies in the dataset, the application of this rule might inadvertently alter valid data points, leading to an unexpected surge in outliers. To detect such scenarios, the system might utilize outlier detection algorithms or statistical methods to compare the number of outliers before and after the rule application.

Illustrative embodiments include proposing, responsive to a determination that the data quality rule increases the number of outliers, to remove the data quality rule. If the system detects an increase in the number of outliers following the application of a data quality rule, it might suggest removing or altering the rule. This could be done through automated notifications or alerts to the user, or the system might even directly modify the rule set depending on the level of automation designed into the system. For instance, if a rule designed to correct date formats inadvertently changes valid dates into incorrect ones, the system could propose removing this rule to mitigate the problem.

Illustrative embodiments include determining a similarity between a first data structure and a second data structure. This might involve comparing the characteristics of the data structures, such as data type, schema, data source, data granularity, and so on. For instance, two data structures might be deemed similar if they both contain sales data (data type), have similar column names (schema), originate from the same sales tracking system (data source), and have data recorded on a daily basis (data granularity). It is to be understood that any characteristics may be used to make this determination, however.

In some embodiments the similarity may be based at least on a data type and a data source. For example, a data structure containing sales data from a retail chain's online store might be considered similar to another data structure containing sales data from the retail chain's physical store, given that both share the same data type (sales data) and data source (the retail chain).

Illustrative embodiments include applying, based on the similarity, a data quality rule associated with the first data structure to a potential outlier in the second data structure. If the system has detected an outlier in the second data structure and determined that this structure is similar to the first one, it could apply a data quality rule that was effective in the first data structure to the outlier in the second one. For instance, if a data quality rule in the first data structure effectively corrected outliers caused by incorrectly entered sales data, and a similar outlier is detected in the second data structure, this rule could be applied to the second data structure as well. This kind of rule portability may allow the system to leverage learnings from one data structure to improve data quality across similar ones, enhancing the overall efficiency and effectiveness of the outlier detection and correction process.

Illustrative embodiments include deleting a data quality rule, responsive to an identification that a shift introduced by the data quality rule matches another observed shift in the data. Deletion of a data quality rule may involve removing or deactivating a predefined constraint or guideline that is used to manage the quality of data. This process may be necessary when a rule becomes irrelevant, counterproductive, or redundant due to changes in the nature or characteristics of the data, or changes in the context or requirements of the data analysis. If a rule was created to introduce a certain shift, and the observed shift in the data later mirrors this shift, it may indicate that the data quality rule itself is causing an unnecessary shift in the data, hence necessitating its removal. For instance, if a data quality rule was implemented to correct a currency conversion error by adjusting the values upwards, and the currency conversion error was subsequently fixed, the data may exhibit an upward shift because the still-active data quality rule is now causing an undesired shift in the data. Thus, deleting this rule can restore the integrity and accuracy of the data.

Illustrative embodiments include an outlier detector that includes a machine learning module configured to detect a potential outlier. An outlier detector equipped with machine learning capabilities may provide a dynamic and adaptable means of identifying outliers. The machine learning model may be designed to learn from data, distinguishing patterns that may not be immediately evident. Thus, in the context of outlier detection, a machine learning model can learn to identify what constitutes an “expected” data point in a given dataset, and subsequently flag instances that deviate significantly from this expectation as outliers. For instance, a machine learning model may be trained using time series of historical data. Once trained, the model may be able to identify outliers based on their similarity to the patterns it has learned from the training data. Alternatively, unsupervised algorithms like K-means clustering could be used, which group data points based on their similarity, and data points that do not fit well into any cluster could be considered outliers. Other machine learning models may be used, however, as would be appreciated by those having ordinary skill in the art upon reviewing the present disclosure.

In some embodiments, training the machine learning module may include providing the machine learning module a time series of historical data. Time series data is a sequence of data points indexed (or listed or graphed) in time order. Examples include daily sales figures for a store. This temporal nature of the data can provide important context for the machine learning model, aiding it in detecting outliers. For instance, an machine learning model trained on a year's worth of daily sales data for a store could learn the regular sales pattern and can identify any significant deviations from this trend (e.g., as a result of a currency conversion error) as potential outliers.

Illustrative embodiments include an outlier corrector that includes a machine learning module configured to propose a new data quality rule to correct a potential outlier. This outlier corrector could utilize, for instance, reinforcement learning or supervised learning approaches to generate suitable rules to correct detected outliers. For example, it could propose a rule that reduces the impact of extremely high or low values in a sales data set, particularly if these values are skewing overall sales figures. The proposed rules could be as simple as replacing the outlier with the mean of the surrounding values or proposing a rule that handles a scaling error (e.g., as a result of a currency conversion).

In some embodiments, training the machine learning module may be based on a user feedback on the proposed new data quality rule. User feedback for instance may be used in reinforcement learning paradigms where the feedback may be used as a signal to reward or punish the model. For instance, if a rule proposed by the model successfully resolves an outlier issue without introducing new issues, the user might provide positive feedback, leading the model to reinforce the strategy it used to generate that rule. On the other hand, if the proposed rule fails to correct the outlier or introduces new anomalies, the user might provide negative feedback, prompting the model to adjust its rule-generation strategy. Over time, this feedback loop can help the model to become increasingly effective at generating useful data quality rules.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for adaptive outlier detection and correction is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

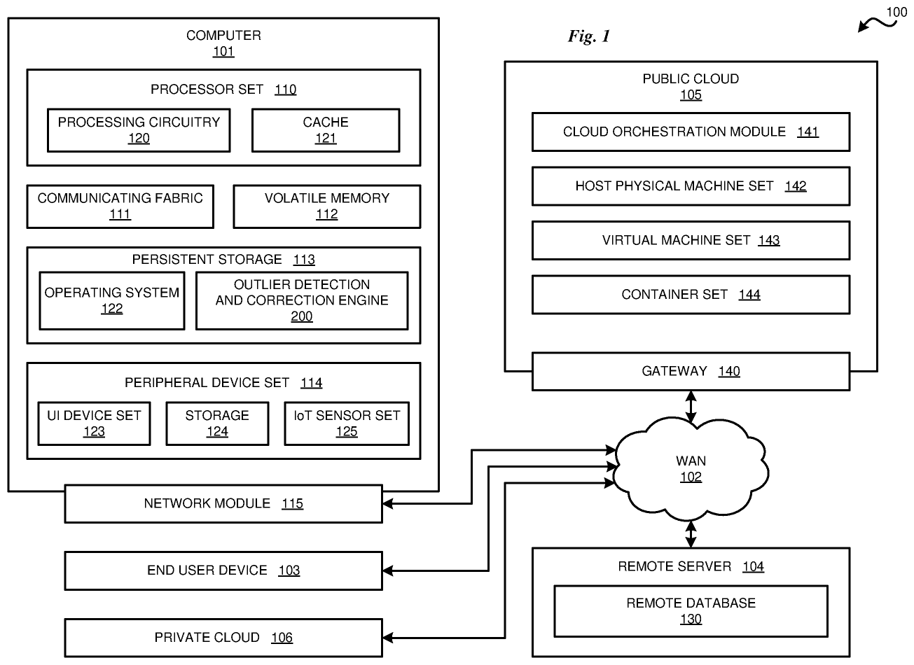

With reference to FIG. 1, this figure depicts a block diagram of a computing environment 100. Computing environment 100 contains an example of an environment for the execution of at least some of the computer code involved in performing the inventive methods, such as outlier detection and correction engine 200 for adaptive outlier detection and correction. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

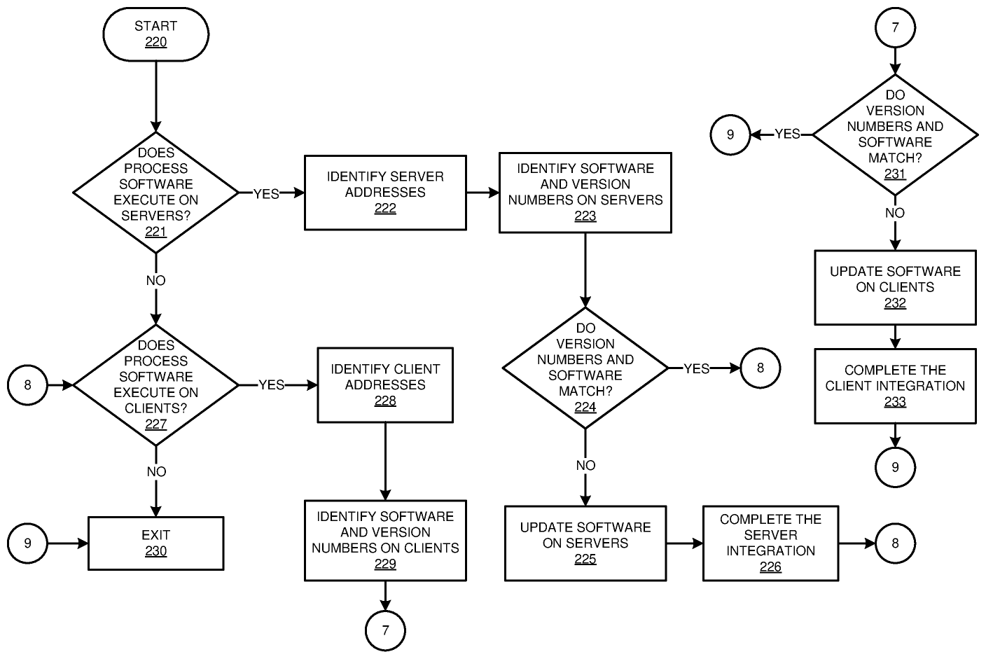

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

If one or more of the version numbers do not match, then the unmatched versions are updated on the clients with the correct versions 232. In addition, if there is missing required software, then it is updated on the clients 232. The client integration is completed by installing the process software on the clients 233. The integration proceeds to 230 and exits.

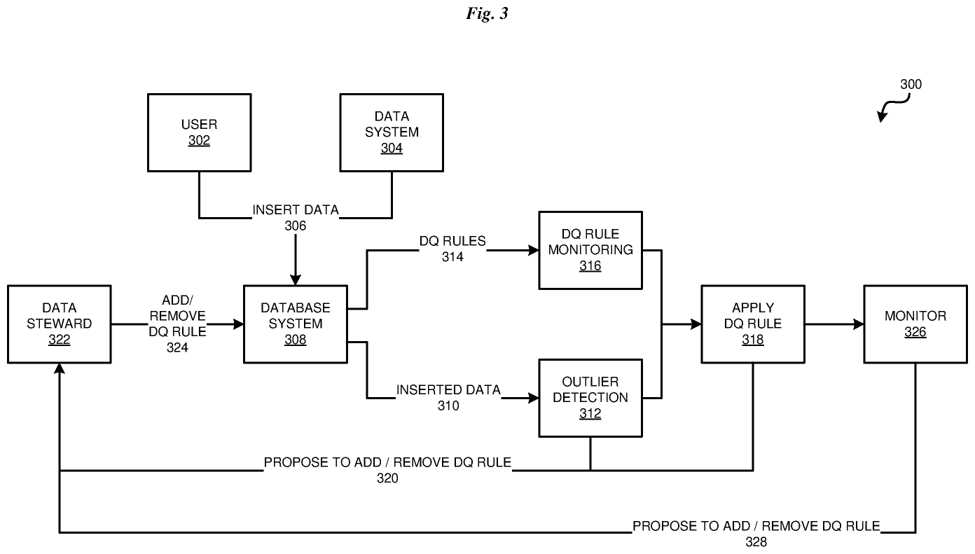

With reference to FIG. 3, this figure depicts a block diagram of an example system for adaptive outlier detection and correction 300, which various illustrative embodiments may implement.

In the depicted example, user 302 may provide data to system 300. The user providing the data may involve manual entry of raw data, importing of structured datasets, or transferring data from other systems or peripheral devices, such as data generated by IoT devices or collected from web forms. For instance, if system 300 is related to an e-commerce platform, the user may provide data in the form of product details, transaction histories, customer feedback, or other relevant information, which could be transmitted via a secure data transfer protocol to ensure data integrity and confidentiality.

Similarly, data system 304 may provide data to system 300. The nature of this system could range from data collectors like sensors or bots to software applications or database systems. The data provision could involve automatic data feeds, API calls, or any form of digital data interchange. For instance, if data system 304 is an inventory management software, it might automatically provide updates about stock levels, sales trends, or supplier information to system 300, which could be an overarching enterprise resource planning (ERP) system.

At block 306, the system may insert received data into database system 308. The data insertion process might encompass several sub-processes, such as data validation, normalization, deduplication, and transformation, to ensure that the incoming data complies with the schema and standards of the database system 308. For example, the system could convert date formats, standardize text entries, remove duplicates, or validate the data before storing the data.

At block 312, the system may perform outlier detection on inserted data 310. The system may use statistical methods like Z-score or IQR, or more complex machine learning techniques, such as clustering or neural networks, to detect anomalies within the dataset. For example, if the data contains sales figures, an outlier detection algorithm might flag unusually high or low sales amounts that significantly deviate from the average sales value.

At block 316, the system may perform data quality rule monitoring on data quality rule(s) 314, abbreviated as “DQ” rules. The system may compare the properties of the inserted data 310 against predefined data quality rules 314 to assess if it meets all the conditions stipulated by these rules. These rules might include checks for completeness, consistency, accuracy, or timeliness. For instance, a data quality rule might state that entries for a particular dataset should not exceed a predetermined threshold.

At block 318, the system may apply a data quality rule. The application of these rules could involve various operations such as data cleaning, data transformation, or data enrichment, depending on the rule's nature. For instance, following the example above, a data quality rule might be used to correct entries for the particular dataset above the predetermined threshold.

At block 320, the system may propose to add or remove a data quality rule. This determination may be based on the performance evaluation of the current rules. This proposal is generated by assessing the current data quality and measuring the impact of each rule on improving data quality. For instance, if a rule that checks for a specific pattern in phone numbers is found to be irrelevant due to a change in the data source, the system might propose to remove this rule.

At block 324, data steward 322 may approve the addition or removal of the data quality rule. Data steward 322 may be a user responsible for data governance and ensuring the quality of data in the system, reviewing the proposed changes. Using their expertise, they may determine whether to add or remove a data quality rule as suggested by the system. For instance, if a new type of data is being collected, the data steward may approve the addition of a new rule that checks the validity of this new data.

In some embodiments, in the case where a machine learning module is configured to propose to add or remove a data quality rule, the data steward may train the machine learning module based on user feedback on the proposed addition or deletion. This feedback may be part of a supervised learning algorithm, acting as labels to guide the learning process of the module. The machine learning module, utilizing techniques such as reinforcement learning, gradient descent, or backpropagation, may gradually refine its ability to propose effective and relevant rules. Over time, as the machine learning model improves, it may autonomously manage data quality rules, thereby reducing the need for the data steward's intervention or eliminating the need for the data steward altogether.

At block 326, the system may monitor the data quality rules. It may use built-in or integrated tools to track the quality of the data and performance of the data quality rules over time. It could also deploy automated alert mechanisms to notify data stewards or other relevant parties if any significant quality issues or anomalies are detected.

At block 328, the system may again propose to add or remove a data quality rule based on the monitoring. This may involve proposing the undoing of previous corrections if they are identified as problematic or incorrect. For example, if an earlier process wrongly identified and corrected an outlier, which later proved to be a valid data point, the system might propose to revert this correction, thereby ensuring the integrity and accuracy of the data. As another example, if a data quality rule is no longer relevant or needed because a conversion error has been fixed, the system may propose to remove that data quality rule.

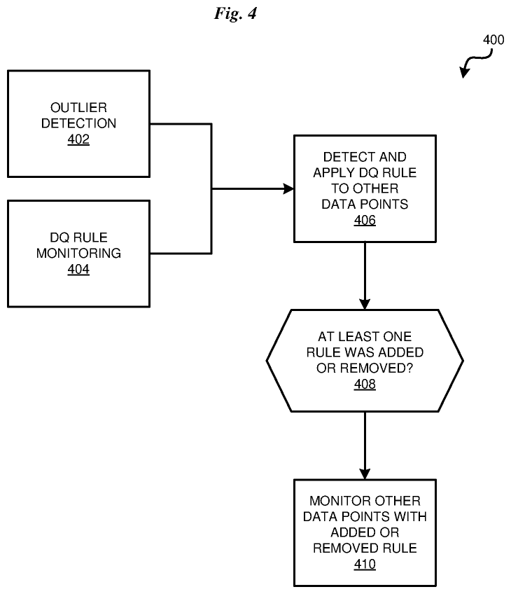

With reference to FIG. 4, this figure depicts a block diagram of an example process for adaptive outlier detection and correction 400, which various illustrative embodiments may implement.

At block 402, the process may perform outlier detection, such as by monitoring inserted data for potential outliers. This step may involve identifying anomalous entries that deviate from other data points. The detection could be based on various statistical or machine learning techniques such as standard deviation, interquartile range (IQR), k-means clustering, or machine learning algorithms, among others, as explained herein. For example, the outlier detection process could identify a high value in a set of sales data, which might suggest a data entry error or a special event.

At block 404, the process may perform data quality rule monitoring. This step may involve periodically inspecting data quality rules incorporated into the system. The process may scrutinize each rule to ensure it effectively addresses the targeted data issues without introducing additional issues. The process may use historical data, simulation, predictive modeling, or any other suitable algorithm to gauge the impact of a data quality rule.

At block 406, the process may detect and apply the data quality rule to other data points. Once such data points are detected, the process may apply the data quality rule to harmonize these data points with the rest of the dataset. For instance, the process might identify a column in a dataset where measurements were erroneously recorded in a different unit of measurement, and apply the data quality rule to convert these values to the correct unit.

At block 408, the process may determine whether at least one rule was added or removed. This step may involve identifying changes in a database of data quality rules. For example, if a data quality rule for checking the validity of email addresses was removed due to a change in data collection strategy, the process may register this modification for future data handling processes.

At block 410 the process may monitor the other data points with the added or removed data quality rule. This step may involve observing these data points to detect any potential adverse effects that may have resulted from the data quality rule. The monitoring could involve tracking key metrics, identifying new anomalies, or comparing the data's behavior before and after the rule change. This monitoring may ensure that the rule changes promote better data quality without unintentionally causing data corruption or degradation.

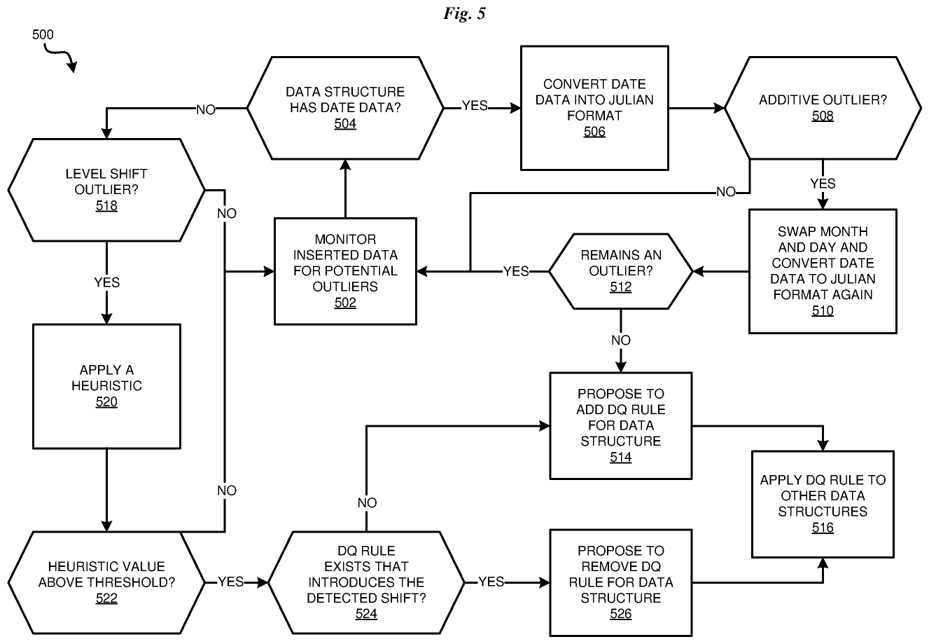

With reference to FIG. 5, this figure depicts a block diagram of an example process for adaptive outlier detection 500, which various illustrative embodiments may implement.

At block 502, the process may monitor inserted data for potential outliers. This step may involve using data processing applications, coupled with analytical tools to identify values deviating from the expected norm. For instance, if the dataset is a collection of customer ages, an entry of 150 might be flagged as a potential outlier.

Once an outlier is identified, at block 504, the process may determine whether a data structure contains date data. The data structure may be any suitable form of data, such as columns, rows, tables, graphs, trees, multi-dimensional matrices, and the like. This step may involve analyzing the format of the data structure holding the potential outlier. This could involve metadata analysis or regular expression pattern matching to recognize common date formats (for instance, “MM-DD-YYYY” or “YYYY/MM/DD”).

If the process determines that the data structure contains date data, at block 506, the process may convert the date data into Julian format (i.e., number of days since November 24, 4714 BC). This conversion could involve manipulating the date using any suitable algorithm. Standardization to Julian dates may allow for easier comparison and mathematical operations on dates.

At block 508, the process may determine whether the potential outlier is an additive outlier. An additive outlier may indicate a deviation at a particular data point. For instance, in a dataset tracking daily sales for a retail store, an additive outlier might be a day where the sales are dramatically higher than normal due to an entry error.

If the process determines that the potential outlier is not an additive outlier, the process may end and the process may restart at block 502 to continue monitoring for outliers. However, if the outlier is additive, the system may proceed to block 510, swapping the day and month in the date and converting it to the Julian format again. This could be a corrective step, especially useful if date values have been systematically entered in a wrong format (like “DD/MM/YYYY” instead of the expected “MM/DD/YYYY”).

At block 512, the process may determine whether the potential outlier remains an outlier. This step may involve reapplying the same statistical or machine learning-based outlier detection algorithms on the corrected data point.

If the process determines that the potential outlier is no longer an outlier, at block 514, the process may infer that the anomaly was due to a day-month inversion and may consequently propose to add a data quality rule specifically designed to automatically correct such an inversion error. However, if the process determines that the potential outlier remains an outlier, the process may not be able to infer a concrete conclusion and may refrain from proposing a data quality rule to rectify the anomaly. Consequently, the process may restart at block 502 to continue monitoring the inserted data for potential outliers.

At block 516, the process may detect other outliers in other data structures and apply the proposed data quality rule to the other data structures. This may help not only rectify current outliers but also prevents similar issues in the future. For instance, if incorrect retail sales data entries were found in different retail data (e.g., retail costs) across multiple columns of data, this step would ensure all such anomalies are corrected. In some embodiments, the other data structures may be identified based on a similarity with the original data structure.

Returning to block 518, if the process determines that the data structure does not contain date data, the process may determine whether the potential outlier is a level shift outlier. A level shift outlier may indicate a deviation at a plurality of data points. For example, if the daily sales data in the same retail store mentioned above changed consistently for a number of days as a result of a currency conversion error (e.g., pounds were incorrectly entered as euros, or vice versa), this could be considered a level shift outlier.

If the process determines that the potential outlier is not a level shift outlier, the process may end and the process may restart at block 502 to continue monitoring for potential outliers.

However, if the process determines that the potential outlier is a level shift outlier, at block 520, the process may apply a heuristic to determine a heuristic value. The heuristic may comprise criteria for determining the validity of a potential outlier, such as criteria based on the data classification, the data type, the table name, the column name, the cell values, and/or whether the column has a subset of the relevant data quality rules, among other factors. The heuristic value may be the sum of the weights of the heuristic criteria, such as all the criteria that the data structure meets. This value may serve as a measure of the likelihood that a level shift in the data structure is valid.

At block 522, the process may determine whether the heuristic value meets a predetermined threshold. The threshold may be dynamic, such as being separately defined for each data source and adjusted based on the percentage of outliers in a rolling window of the data that a data source inserted. For instance, if more outliers are found, the data is more likely to be an outlier, and therefore, the threshold may be lowered. Conversely, if fewer outliers are detected, the threshold may be increased, making it harder for a data point to be classified as an outlier. This dynamic threshold adjustment may help accommodate variability in different data sources and maintain the balance between catching true outliers and avoiding false positives. Furthermore, it can be manually adjusted to meet specific requirements or to fine-tune the outlier detection process.

For example, consider a series of data entries capturing daily product sales from a retail store. Suppose this series shows a consistent increase in sales over a period of weeks, far outpacing normal growth rates. The data structure may be a time-series column labeled “Product Sales,” containing numeric values. The data classification may be financial, the data type may be numeric, the table name may be “Retail Sales,” and the column name may be “Product Sales.” The cell values may show a consistent increase that appears out of sync with known market trends, and this column already has a subset of data quality rules, for example, rules to correct potential typing errors or currency conversions. By applying the heuristic weights to these factors, the process may give higher weightage to the consistent increase in cell values and the financial data classification as these factors strongly suggest an anomaly. For instance, an unexpected, consistent increase in sales may not align with the store's promotional activities or any known market events, hinting at a possible level shift outlier as the result of a currency conversion error. Consider further that the “Product Sales” column is already governed by certain data quality rules which are supposed to correct common errors but have not addressed this anomaly. Therefore, this situation may prompt a high heuristic value, exceeding the predetermined threshold, indicating a likely level shift outlier that needs to be addressed.

If the process determines that the heuristic value is below the threshold, the process may end and the process may restart at block 502 to continue monitoring for potential outliers. However, if the process determines that the heuristic value is above the threshold, at block 524, the process may investigate whether a data quality rule exists that introduces the shift observed in the potential outlier. For instance, if a level shift outlier has increased values by a scaling factor of 1.19, it would look for a rule that increases values by the same amount.

If the process determines that there is no data quality rule that introduces the shift of the potential outlier, at block 514, the process may propose adding a data quality rule for the data structure to handle the potential outlier. The newly proposed rule may function to alter the data in a way that counterbalances the observed shift, thereby restoring the integrity of the data in the relevant data structure. The rule proposal process can be aided by machine learning techniques, helping to predict the most effective rule adjustments based on past data behavior and historical rule performance.

If the process determines that there is a data quality rule that introduces the shift of the potential outlier, at block 526, the process may propose removing the data quality rule. This process may involve deleting the data quality rule from a database of data quality rules or another repository of them. The presence of such a rule could indicate that it is unnecessarily manipulating data, hence producing the outliers. Removing this rule may, therefore, improve the overall quality of the data, ensuring that the data is representative of actual phenomena and is not overcorrected or skewed by data quality rules.

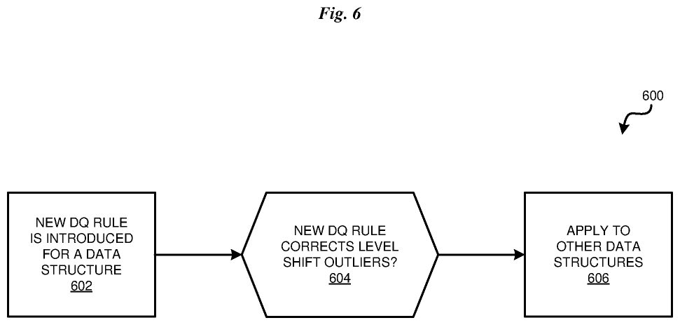

With reference to FIG. 6, this figure depicts a block diagram of an example process for data quality rule monitoring 600, which various illustrative embodiments may implement.

At block 602, a new data quality rule may be introduced for a data structure. This step might entail introducing a rule that governs a particular characteristic of the data within that data structure. For example, a data quality rule could correct a currency conversion error in a data column. In some embodiments, the new data quality rule may be introduced by a data steward.

At block 604, the process may determine whether the new data quality rule corrects level shift outliers. This step may entail the comparison of data patterns or distributions before and after the application of the rule. For instance, the process might analyze whether the application of the rule results in a change in the mean, median, or distribution of a plurality of data points in the data structure. As another example, the new data quality rule may itself indicate whether it corrects level shift outliers (e.g., in its metadata).

At block 606, the process may apply the new data quality rule to other data structures if it corrects level shift outliers. This step may involve identifying similar data structures in terms of data type, value range, or relevance to the original data structure, and then applying the same rule to these data structures. The assumption here may be that similar data structures would likely benefit from the same data quality rules. For example, if a column contained financial data and the new rule corrected a currency conversion error, other financial data columns could also have this rule applied to correct this same currency conversion error.

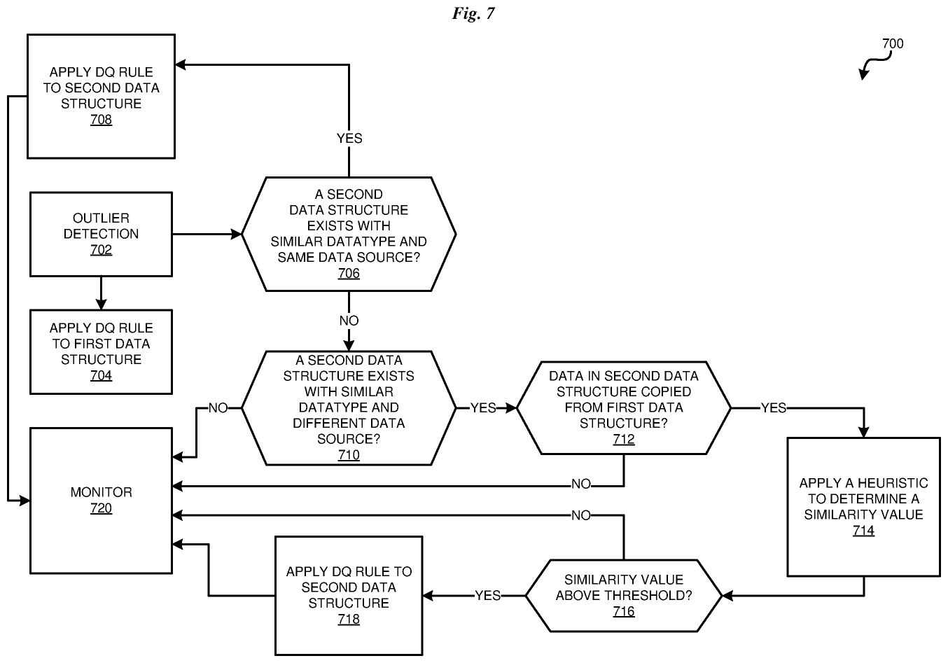

With reference to FIG. 7, this figure depicts a block diagram of an example process for applying a data quality rule to data 700, which various illustrative embodiments may implement.

At block 702, the process may perform outlier detection. This might be implemented via a variety of methods, as previously explained. For example, the process may involve applying a Z-score, Mahalanobis distance, or Density-Based Spatial Clustering of Applications with Noise (DBSCAN), machine-learning methods, or any other suitable process.

At block 704, the process may apply a data quality rule to a first data structure. This could be the application of a statistical or algorithmic transformation to correct, modify or remove the detected outlier. For example, if the outlier is a data entry error (a patient's weight entered as 1500 lbs instead of 150 lbs), the rule might replace the value with a more plausible one. Alternatively, if the outlier is due to a unit inconsistency (one value entered in kg while others are in lbs), a unit conversion rule might be applied.

At block 706, the process may determine whether there is a second data structure with a similar data type and the same data source as the first data structure. This step might involve comparison of metadata attributes or use of data cataloging tools. For example, if the first data structure was a finance-related table with data from a specific database, it could check for other finance-related tables with data from the same database.

If the process determines that there is a second data structure with a similar data type and the same data source as the first data structure, at block 708, the process may propose applying the data quality rule to the second data structure. For example, if the data quality rule was applied to rectify a unit inconsistency in the first data structure, it may propose applying the same rule to the second data structure assuming a similar inconsistency might exist. In some embodiments, this step may include training a machine learning model to apply the data quality rule to the second data structure. This training may involve gathering historical data from the second data structure so that the model may learn to detect outliers based on this historical data. This learned model can then be used to predict whether future data points will require the same data quality rule. The training process may also include validating and testing the model for accuracy and robustness, and fine-tuning model parameters as needed. Subsequently, after applying the data quality rule to the second data structure, the process may end and continue to monitor for potential outliers at block 720.

If the process does not determine that there is a second data structure with a similar data type and the same data source as the first data structure, at block 710, the process may determine whether there is a second data structure with a similar data type and a different data source as the first data structure. This step might involve comparison of metadata attributes or use of data cataloging tools. For instance, if the first data structure was a finance-related table from one database, it might now look for similar finance-related tables in another database.

If the process does not determine that there is a second data structure with a similar data type and a different data source as the first data structure, the process may end and continue to monitor for potential outliers at block 720.

However, if the process determines that there is a second data structure with a similar data type and a different data source as the first data structure, at block 712, the process may determine whether the data in the second data structure was copied from the first data structure. The aim of this step may be to determine if the data contained in the second data structure was duplicated or derived from the first data structure, and it may leverage data lineage techniques, tracking the data's lifecycle across the system or compare unique identifiers or hash codes, or any other suitable technique. Data lineage may provide a historical record of the data's journey, allowing for a detailed exploration of its origins, transformations, and destinations within the system. Another approach may be through the comparison of unique identifiers or hash codes. A unique identifier is a symbol or a set of symbols that uniquely represents a data entity within a database, and a hash code is a numeric representation of a piece of data that has been generated by a hash function. Both unique identifiers and hash codes can be employed to identify identical data items across different data structures. If the unique identifiers or hash codes match, it may be a strong indication that the data was copied.

If the process determines that the data in the second data structure was copied from the first data structure, at block 714, the process may apply a heuristic to determine a similarity value between the data in the first and second data structures. This process may involve the use of a statistical measure like correlation or mutual information, or a machine learning model like a classifier or clusterer trained on the first data structure and then applied to the second. Conversely, if the process determines that the data in the second data structure was not copied from the first data structure, the process may end and continue to monitor for potential outliers at block 720.

At block 716, the process may determine whether the similarity value meets a similarity threshold. If the similarity is above this threshold, it may indicate that the two data structures are similar enough to warrant the application of the same data quality rule.

If the process determines that the process determines that the similarity value does not meet the similarity threshold, the process may end and continue to monitor for potential outliers at block 720. This step might involve generating a report or alert to data stewards or executing the rule on the data structure directly, depending on the specific application.

If the process determines that the similarity value meets the similarity threshold, at block 718, the process may propose adding or removing the data quality rule to the second data structure. This may involve the same or similar process as discussed above in connection with block 708.

At block 720, the process may continue to monitor for potential outliers. This might involve setting up periodic scans of the data, implementing continuous anomaly detection algorithms, or using a time-triggered control system to continually or periodically check for outliers in the data structures.

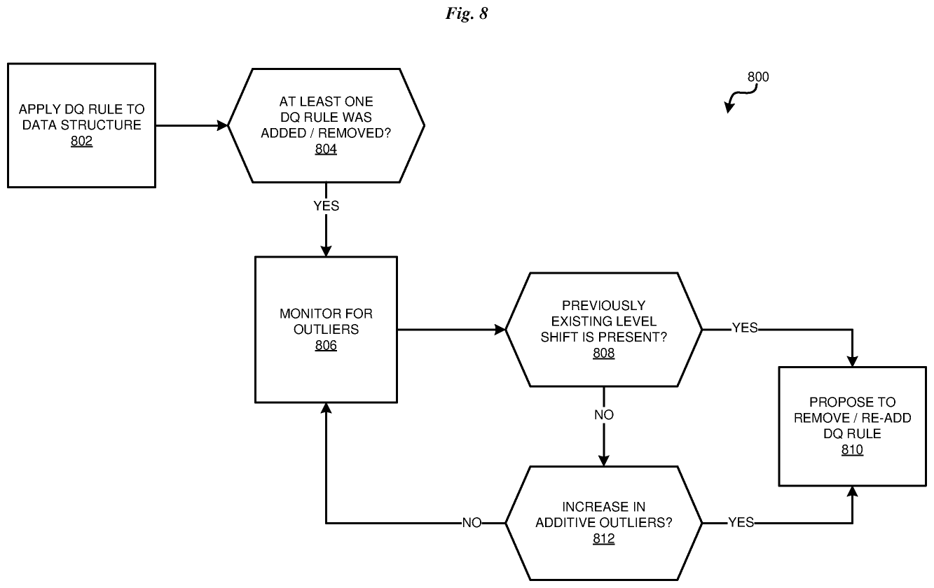

With reference to FIG. 8, this figure depicts a block diagram of an example process for monitoring for outliers 800, which various illustrative embodiments may implement.

At block 802, the process may apply a data quality rule to a data structure. The data quality rule could be in the form of limits or restrictions on the possible values a certain field or attribute can take, as discussed.

At block 804, the process may determine whether at least one data quality rule was added or removed. This step may involve maintaining a log or history of changes made to the data quality rules, allowing the process to check for any alterations. A modification in the rules may occur due to changes in the requirements or constraints of the system.

If the process determines that at least one data quality rule was added or removed, at block 806, the process may monitor for outliers in the data structure. For instance, if a rule was added specifying that the “age” field in a dataset should never exceed 150, the process will begin scanning for any entries where the age exceeds this threshold.

Responsive to detecting an outlier, at block 808, the process may determine whether a previously-existing level shift is present. This may involve checking for significant shifts in the data distribution that may have resulted from past changes in the system or the data input method. For instance, a change in the system's measurement units from kilograms to grams would cause a level shift.

If the process determines that the previously-existing level shift is not present, at block 810, the process may propose removing or re-adding a data quality rule associated with the previously-existing level shift. This process may involve using a version control system or rule management system to make these modifications.

At block 812, the process may determine whether there is an increase in the number of additive outliers. These may be outliers that may occur at a particular data point, such as due to a sudden change or fluctuation in the data. This step may involve tracking the number of these outliers over time and comparing it to a predefined acceptable limit.

If the process determines that there is an increase in the number of additive outliers, at block 810, the process may propose removing or re-adding the data quality rule associated so as to reduce the increase in additive outliers. This may help maintain data consistency, even after the introduction of irrelevant or incorrect data quality rules.

If the process determines that there is not an increase in the number of additive outliers, the process may resume monitoring for outliers at block 806.

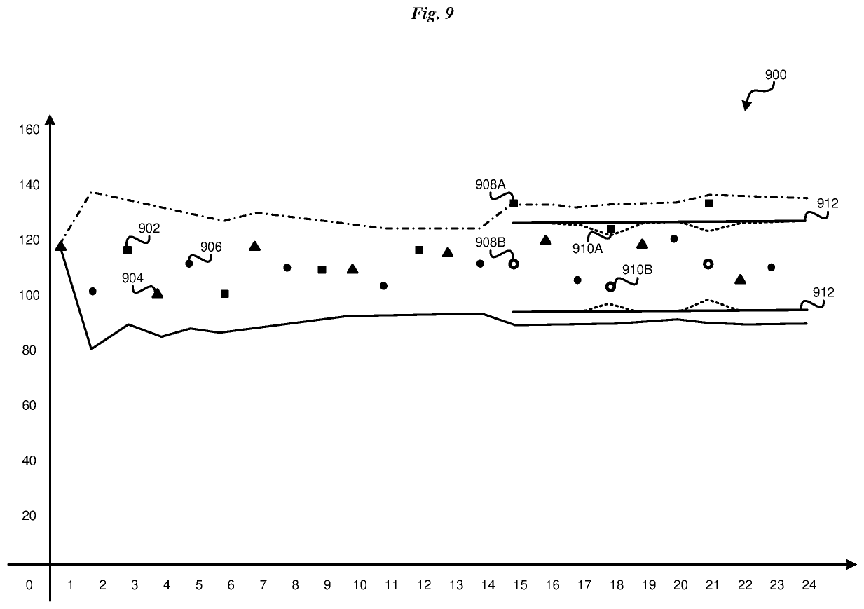

With reference to FIG. 9, this figure depicts a graphical representation of an example process for detection and correction of a level shift outlier 900.

In the illustrative example, there may be three data sources (first data source 902, second data source 904, and third data source 906) in a data structure, such as three columns (one for each data source). From time 15 and onward, the values from first data source 902 may be shifted by a value of 1.19, which may be representative of an incorrect currency conversion from pounds (£) to euros (€).

The system may be configured to detect outliers in data and determine a correction for the outlier. For example, as shown, the system detects the first shifted value 908a as an outlier and determines a correction depicted as a first corrected value 908b. First corrected value 908b may signify the corrected value after counteracting the erroneous currency conversion, thus restoring the data point to its original value in pounds.

As the system continues to monitor the data, it may encounter a second shifted value 910a. As further show, the second shifted value 910a may be below threshold 912. Because the first shifted value 906a was detected as an outlier, the system may lower the threshold for first data source 902, such that second shifted value 910a may also be detected as an outlier. By decreasing the threshold, the system may become more sensitive to smaller variations in the data from this particular source.

This adjustment may enable the system to correctly identify the second shifted value 910a as an outlier and correct it as second corrected value 910b, despite it originally falling just below the initial threshold. This dynamic adaptation of the threshold may contribute to the system's ability to effectively handle multiple data sources with distinct behaviors and patterns.

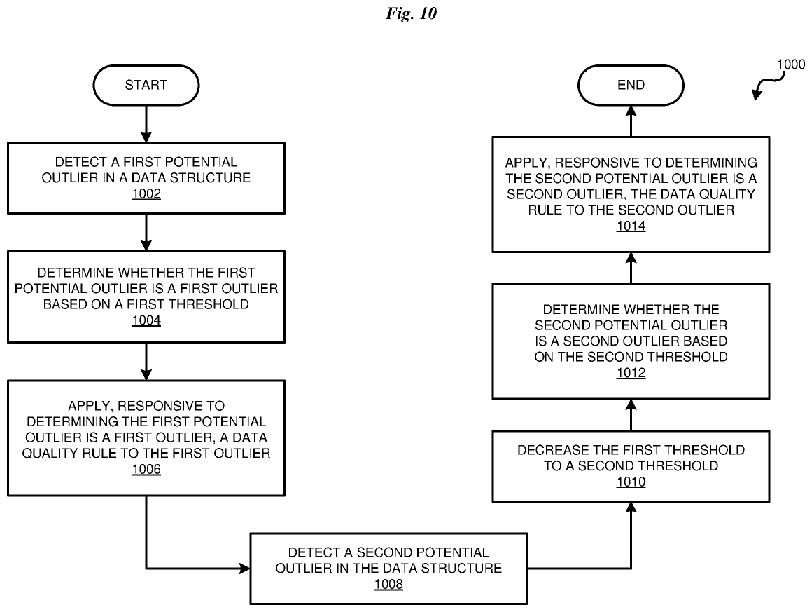

With reference to FIG. 10, this figure depicts a block diagram of an example process for outlier detection and correction in accordance with an illustrative embodiment 1000. The example block diagram of FIG. 10 may be implemented using outlier detection and correction engine 200 of FIG. 1.

In the illustrative embodiment, at block 1002, the process may detect a first potential outlier in a data structure. For instance, in a dataset of daily sales figures, a potential outlier could be a single day where the sales are excessively high or low compared to other days. Potential outliers could be detected through a variety of statistical methodologies like the Z-Score method or Interquartile Range (IQR) method, or machine learning techniques, as explained before.

At block 1004, the process may determine whether the first potential outlier is a first outlier based on a first threshold. Thresholding may involve contrasting the data point against a specified boundary value. This boundary could be dependent on the standard deviation (as in Z-score), percentiles (as in IQR), or any other appropriate metric. For instance, any data point above three times the standard deviation could be deemed an outlier.

At block 1006, the process may apply, responsive to determining the first potential outlier is a first outlier, a data quality rule to the first outlier. This rule could be designed to correct or mitigate the outlier's impact. For example, if the outlier results from an entry error, such as an extra zero added to a value, the rule might involve substituting the outlier with an estimated value, perhaps derived from the median or mean of neighboring data points, or from a predictive model trained on the rest of the data.

At block 1008, the process may detect a second potential outlier in the data structure. This may indicate the iterative nature of the process, which repeatedly scans for and addresses potential outliers. This second outlier could be spotted using similar or different methods from those used for the first outlier, depending on the characteristics of the data or the requirements of the specific analysis.

At block 1010, the process may decrease the first threshold to a second threshold. This modification could be informed by the data distribution post the first correction or could be driven by the analytical requirements of the task at hand. A reduced threshold could potentially flag more data points as outliers.

At block 1012, the process may determine whether the second potential outlier is a second outlier based on the second threshold. Given that this threshold is lower, it is likely that more data points will be categorized as outliers compared to the use of the first threshold.

At block 1014, the process may apply, responsive to determining the second potential outlier is a second outlier, the data quality rule to the second outlier. This indicates the corrective measure undertaken to handle the identified outlier, consequently enhancing the quality and reliability of the data. Depending on the nature of the outlier or the demands of the data analysis task, this rule could be the same or different from the first rule. For instance, if the first outlier was due to a measurement error and the second due to a systemic bias, different correction strategies may be required.

It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises.” “comprising.” “includes,” “including.” “has,” “having.” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment.” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
detecting, by an outlier detector, a first potential outlier in a data structure;
determining, by the outlier detector, whether the first potential outlier is a first outlier based on a first threshold;
applying, by an outlier corrector, responsive to determining the first potential outlier is a first outlier, a data quality rule to the first outlier;
detecting, by the outlier detector, a second potential outlier in the data structure;
decreasing, by the outlier detector, the first threshold to a second threshold;
determining, by the outlier detector, whether the second potential outlier is a second outlier based on the second threshold; and
applying, by the outlier corrector, responsive to determining the second potential outlier is a second outlier, the data quality rule to the second outlier.

2. The method of claim 1, wherein determining whether a potential outlier is an outlier further comprises:
determining whether the potential outlier is an additive outlier indicating a deviation at a particular data point;
converting, responsive to a determination that the potential outlier is an additive outlier, the potential outlier to a standardized value; and
determining whether the potential outlier is an outlier by applying a threshold to the standardized value.

3. The method of claim 1, wherein determining whether a potential outlier is an outlier further comprises:
determining whether the potential outlier is a level shift outlier indicating a deviation at a plurality of data points;
applying, responsive to a determination that the potential outlier is a level shift outlier, a heuristic to the potential outlier to compute a heuristic value; and
determining whether the potential outlier is an outlier by applying a threshold to the heuristic value.

4. The method of claim 1, further comprising:
applying the data quality rule to a plurality of potential outliers in the data structure;
determining, based on the applying, whether the data quality rule increases a number of outliers; and
proposing, responsive to a determination that the data quality rule increases the number of outliers, to remove the data quality rule.

5. The method of claim 1, further comprising:
determining a similarity between the data structure and a second data structure based at least on a data type and a data source; and
applying, based on the similarity, the data quality rule to a potential outlier in the second data structure.

6. The method of claim 1, wherein the outlier detector includes a machine learning module configured to detect a potential outlier, and wherein training the machine learning module includes providing the machine learning module a timeseries of historical data.

7. The method of claim 1, wherein the outlier corrector includes a machine learning module configured to propose a new data quality rule to correct a potential outlier, and wherein training the machine learning module is based on a user feedback on the proposed new data quality rule.

8. The method of claim 1, wherein the data structure includes a table comprising a plurality of columns, and the first potential outlier and the second potential outlier are associated with a column in the plurality of columns.

9. The method of claim 1, wherein the first threshold is based at least on one of a mean, a median, and a standard deviation.

10. A computer program product comprising one or more computer readable storage media, and program instructions collectively stored on the one or more computer readable storage media, the program instructions executable by a processor to cause the processor to perform operations comprising:
detecting, by an outlier detector, a first potential outlier in a data structure;
determining, by the outlier detector, whether the first potential outlier is a first outlier based on a first threshold;
applying, by an outlier corrector, responsive to determining the first potential outlier is a first outlier, a data quality rule to the first outlier;
detecting, by the outlier detector, a second potential outlier in the data structure;
decreasing, by the outlier detector, the first threshold to a second threshold;
determining, by the outlier detector, whether the second potential outlier is a second outlier based on the second threshold; and
applying, by the outlier corrector, responsive to determining the second potential outlier is a second outlier, the data quality rule to the second outlier.

11. The computer program product of claim 10, wherein determining whether a potential outlier is an outlier further comprises:
determining whether the potential outlier is an additive outlier indicating a deviation at a particular data point;
converting, responsive to a determination that the potential outlier is an additive outlier, the potential outlier to a standardized value; and
determining whether the potential outlier is an outlier by applying a threshold to the standardized value.

12. The computer program product of claim 10, wherein determining whether a potential outlier is an outlier further comprises:
determining whether the potential outlier is a level shift outlier indicating a deviation at a plurality of data points;
applying, responsive to a determination that the potential outlier is a level shift outlier, a heuristic to the potential outlier to compute a heuristic value; and
determining whether the potential outlier is an outlier by applying a threshold to the heuristic value.

13. The computer program product of claim 10, further comprising:
applying the data quality rule to a plurality of potential outliers in the data structure;
determining, based on the applying, whether the data quality rule increases a number of outliers; and
proposing, responsive to a determination that the data quality rule increases the number of outliers, to remove the data quality rule.

14. The computer program product of claim 10, wherein the outlier detector includes a machine learning module configured to detect a potential outlier, and wherein training the machine learning module includes providing the machine learning module a timeseries of historical data.

15. The computer program product of claim 10, wherein the outlier corrector includes a machine learning module configured to propose a new data quality rule to correct a potential outlier, and wherein training the machine learning module is based on a user feedback on the proposed new data quality rule.

16. A computer system comprising a processor and one or more computer readable storage media, and program instructions collectively stored on the one or more computer readable storage media, the program instructions executable by the processor to cause the processor to perform operations comprising:
detecting, by an outlier detector, a first potential outlier in a data structure;
determining, by the outlier detector, whether the first potential outlier is a first outlier based on a first threshold;
applying, by an outlier corrector, responsive to determining the first potential outlier is a first outlier, a data quality rule to the first outlier;
detecting, by the outlier detector, a second potential outlier in the data structure;
decreasing, by the outlier detector, the first threshold to a second threshold;
determining, by the outlier detector, whether the second potential outlier is a second outlier based on the second threshold; and
applying, by the outlier corrector, responsive to determining the second potential outlier is a second outlier, the data quality rule to the second outlier.

17. The computer system of claim 16, wherein determining whether a potential outlier is an outlier further comprises:
determining whether the potential outlier is an additive outlier indicating a deviation at a particular data point converting, responsive to a determination that the potential outlier is an additive outlier, the potential outlier to a standardized value; and
determining whether the potential outlier is an outlier by applying a threshold to the standardized value.

18. The computer system of claim 16, wherein determining whether a potential outlier is an outlier further comprises:
determining whether the potential outlier is a level shift outlier indicating a deviation at a plurality of data points applying, responsive to a determination that the potential outlier is a level shift outlier, a heuristic to the potential outlier to compute a heuristic value; and
determining whether the potential outlier is an outlier by applying a threshold to the heuristic value.

19. The computer system of claim 16, wherein the outlier detector includes a machine learning module configured to detect a potential outlier, and wherein training the machine learning module includes providing the machine learning module a timeseries of historical data.

20. The computer system of claim 16, wherein the outlier corrector includes a machine learning module configured to propose a new data quality rule to correct a potential outlier, and wherein training the machine learning module is based on a user feedback on the proposed new data quality rule.
